(19) United States
(12) Patent Application Publication
(10) Pub. No.: US 2011/0285634 A1
(43) Pub. Date: Nov. 24, 2011

(54) PORTABLE DATA ENTRY DEVICE

(75) Inventors: Kian Chuan Lim, Oakville (CA); Sudy Shen, Melbourne, FL (US)

(73) Assignee: Karbonstream Corporation, Oakville (CA)

(21) Appl. No.: 13/107,349

(22) Filed: May 13, 2011

Related U.S. Application Data
(60) Provisional application No. 61/347,505, filed on May 24, 2010.

(51) Int. Cl. G06F 3/02; G06F 3/042; G06F 3/041

(52) U.S. Cl. 345/169; 345/173; 345/175

(57) ABSTRACT

The invention is a portable data entry device that allows a user to record hand written material on paper using standard writing tools while simultaneously recording an electronic copy of the written material for subsequent processing and storage on suitable data processing and storage devices. The inventive device includes data processing software which performs an initial analysis of the electronically recorded hand writing and encodes non-ambiguous characters into a compressed character encoding format and stores the encoded data along with the remaining ambiguous character data in local storage memory. The encoded non-ambiguous character data is subsequently transmitted along with the remaining ambiguous character data to a base data processing device for further character recognition data processing.

### CROSS REFERENCE TO RELATED APPLICATIONS

This application claims priority from U.S. provisional application Ser. No. 61/347,505, filed May 24, 2010, which is hereby incorporated by reference in its entirety.

### BACKGROUND OF THE INVENTION

1. Field of the Invention

The field of the invention is portable data entry devices in general and in devices which capture hand written data both on paper and electronically in particular for use in educational, medical and business environments.

2. Description of the Related Art

There have been many attempts to provide devices suitable for entering hand written data for subsequent electronic processing and storage, ranging from hand held personal digital assistants (PDAs) to larger writing tablets attached to a dedicated personal computer. Other methods include digital “pens” which use optical, RF, or magnetic sensing means to track the tip of the pen as it is used to write hand written data on a suitable writing surface.

It has been recognized that it is advantageous to combine an electronic digitizing writing device with the use of standard writing paper and pens, or pencils so that users can continue to use tools they feel comfortable with while providing for the added advantages of having an electronic copy of the written documents they produce. U.S. Pat. No. 5,631,741 by Matthews discloses one such system which includes the use of a touch sensitive area under a piece of paper which records an image of the writing as pixel positions which are stored in a memory array which can be later read out to a computer. The '741 patent uses vector graphics to represent characters which typically use less memory to store than bit-mapped representations but the apparatus uses an extremely large number of conductors to record pen position which makes it impractical to manufacture and thereby limits the resolution of the electronic writing surface.

U.S. Pat. No. 6,396,481 by Challa et al. discloses a digitizing writing device that captures ink data on an ink capturing device while simultaneously capturing electronic pen stroke and transmitted said data with a built in wireless transceiver to an adjacent electronic image display surface. The invention is an overly complex arrangement of separate devices and while capturing writing strokes electronically has no provision for intelligently recognizing characters.

U.S. Pat. No. 5,629,499 by Flickinger et al. discloses a writing board upon which information is written on paper while simultaneously is recorded digitally such that users can retain both copies. The patent further discloses the use of a bar code reader on the writing board which scans in a bar code recorded on the writing paper so that the paper and digital copies can be linked for further document processing and storage. The '499 invention discloses the use of an active pen and board system and suffers from the operational possibility that the pen may get misplaced, lost or damaged which would make the writing board in-operative. Another disadvantage of a prescribed active pen is that it might be uncomfortable and/or difficult to use for people who are used to using their own preferred writing tools.

The fundamental unit of writing that is captured by devices such as those discussed above is the stroke, which is digitally represented by a sequence of x-y coordinate pairs generated as the tip of a pen or pencil is pressed upon and moved over the digitizing surface. Characters, either alphabetic or numerical, are assemblies of a varying number of such constituent strokes. Information about constituent strokes, such as the order in which they are made or the velocity of the pen tip during stroke formation can be used to distinguish and identify the individual strokes and can form the basis for automatically recognizing a written character. For example, an “S” appears visually similar to a “5” but the two can be discriminated by stroke analysis as an “S” is generally made with one stroke while a “5” is generally made with 2 or 3 separate strokes.

Another common method of automatic character recognition is to analyze the visual appearance of a written character after it has been written using a variety of techniques which include those known in the art as Intelligent Character Recognition (ICR), Intelligent Word Recognition (IWR) and Optical Mark Recognition (OMR). These methods which may include the use of neural networks are used to recognize both hand printed characters and cursive writing. U.S. Pat. No. 5,491,758 by Bellegarda et al. discloses a character recognition system that uses both dynamic stroke based character recognition and static optical character recognition to improve recognition accuracy over what is achievable by using either type of recognition alone.

The '758 method uses two full computationally intensive processes in parallel and then combines the results in a third process to obtain a result that is better than either process singularly. While improving the results of character recognition the '758 method employs extremely complex algorithms and requires extensive data processing and power consumption at the primary device and is thus not suitable for a portable, inexpensive electronic writing device.

Typically when using stroke analysis to determine the identity of a written character input stroke data is acquired and compared to a reference set of strokes and the identity of the stroke is decided by a best case match between the input stroke and a stroke in the reference set. This process continues until a set of input strokes is identified and compared with a character reference set and a best case match is made between the identified set of input strokes and a reference character. U.S. Pat. No. 6,968,083 by Williams et al. describes a character recognition system which features two recognition sub-processes, one for character elements (strokes), and the other for characters (assemblies of strokes) which proceed asynchronously. To improve the efficiency of the system, the strokes and characters in the reference sets are organized by their expected frequency so that the most likely matches are tested first. The '083 patent is intended for use in a compact pen-based writing device which allows a user to write with ink on paper while electronically recording and analyzing the motion of the pen tip by on-board detector and data processing means. After processing, a linear mass dump of character data, already converted to a standardized faun, is sent via a wireless transmitter to a PC for subsequent word processing. The pen-based device of the '083 is disadvantageous because it is larger and heavier than typically used writing tools and users can find it uncomfortable and/or difficult to use. Additionally, the pen-based system lacks means for registering the electronic version of the paper-based handwriting, and the volumetric constraint of the interior of the pen restricts the size and effectiveness of the data processing components that can be used to recognize the handwriting.

It has been proposed to use electronic data entry apparatus as data entry tools for educational, medical and business environment users that produces a paper based copy of hand writing along with an electronic copy suitable for computer based processing and storage. Ideally such devices would be portable, inexpensive to purchase and operate and be comfortable and natural to use. So far, there is no existing electronic writing technology that can meet these requirements.

### BRIEF SUMMARY OF THE INVENTION

It is an object of this invention to provide a portable data entry apparatus for educational, medical and business environment users that produces a paper based copy of hand writing along with an electronic copy of the hand written data for subsequent processing and storage by computers that overcomes the deficiencies and limitations of prior art apparatus.

It is another object of the present invention to provide an apparatus and a method which allows a user to write in a natural way using a standard writing implement such as a pencil or pen on a familiar sheet of paper while recording the writing strokes electronically for subsequent processing, transmission and manipulation using computer software.

It is a further object of the invention to provide an apparatus which achieves the objectives mentioned above which is also portable, durable and inexpensive to manufacture and maintain.

Another object of the invention is to provide a portable battery powered data entry device which includes data storage, data processing and data transmission means which can be used selectively to minimize the use of power used while in operation and to maximize the amount of time the device is in a ready to use mode.

It is a further object of the invention to provide a portable data entry apparatus where the electronic copy of hand written data is stored as vector data along with timing information which can be used to later display the hand written data in a stroke sequential manner.

It is another object of the invention to provide a plurality of such portable data entry apparatus for simultaneous use in an educational, medical or business environment where each individual data entry apparatus transmits data to a base data processing unit.

It is a further object of the invention to provide a plurality of portable data entry apparatus each having local data storage and data processing means which are capable of acting co-operatively to jointly perform a data processing task assigned and controlled by a base data processing unit.

It is yet another object to provide an apparatus and method for producing electronic copies of hand written material which are robustly indexed to the original paper copies so that both types of documents may be used in further data processing in addition to existing independently as valuable back-up copies.

It is yet a further object of the invention to provide an apparatus which achieves all of the above objects which also includes interactive signaling means whereby users of the apparatus can communicate with an instructor or supervisor through software run on a base data processing unit and/or another portable data entry device.

It is another object of the invention to provide an apparatus which achieves all of the above objects which also includes means for changing the data input mode of the writing device from handwriting to alternate modes such as a virtual alpha-numeric keypad or a virtual computer keyboard.

These and other objects are achieved by providing a portable data entry apparatus which includes: a pressure sensitive digitizer upon which a piece of standard sized writing paper can be placed which electronically records pen or pencil tip position along with timing data representing writing strokes made upon the paper by a pencil or pen; an on-board central processing unit which includes software means for mapping input writing strokes to a library of standardized elementary writing strokes, assembling the mapped writing strokes into candidate symbols (by describing them in terms of spatial and temporal parameters) and determining if the candidate symbols belong to a set of non-ambiguous alpha-numeric characters; wireless data transmission means; and a base data processing device which includes character recognizing means for recognizing alpha-numeric characters represented by vector data whereby the inventive portable data entry device converts non-ambiguous candidate alpha-numeric characters into a compressed encoded data format, such as ASCII, and transmits the encoded data along with the non-encoded, ambiguous candidate character data to the base data processing unit.

In a preferred embodiment of the invention vector and timing data representing the original writing strokes is also transmitted to the base data processing unit allowing stroke sequential playback of the written material. The non-encoded data is then processed by the character recognizing means of the base data processing device and a complete encoded version of the original hand written material is assembled and stored within the base processing device for subsequent use. The use of some initial character recognition data processing within the portable data entry device reduces the amount of data processing required at the base data processing device which can be substantial in situations where many portable data entry devices are used simultaneously. In a preferred embodiment of the invention the amount of data processing attempted locally by a portable data entry device is flexibly governed by the availability of local resources including the amount of remaining battery power.

### BRIEF DESCRIPTION OF THE DRAWINGS

FIG. 1a) is a general illustration of the main physical features of the inventive portable data entry device.

FIG. 1b) depicts a plurality of inventive portable data entry devices operating simultaneously and communicating wirelessly.

FIG. 2 is a general block diagram of the functional components of the inventive portable data entry device.

FIG. 3 is flowchart illustration the flow of data through the portable data entry device.

FIG. 4 is a graphical representation of character stroke representation of numerical characters in accordance with the method of the invention.

FIG. 5 illustrates a data look up table of elementary stokes and associated characters located within the portable data entry device operating software.

FIG. 6 illustrates a feedback window module, running on a base data processing device

### DETAILED DESCRIPTION OF THE INVENTION

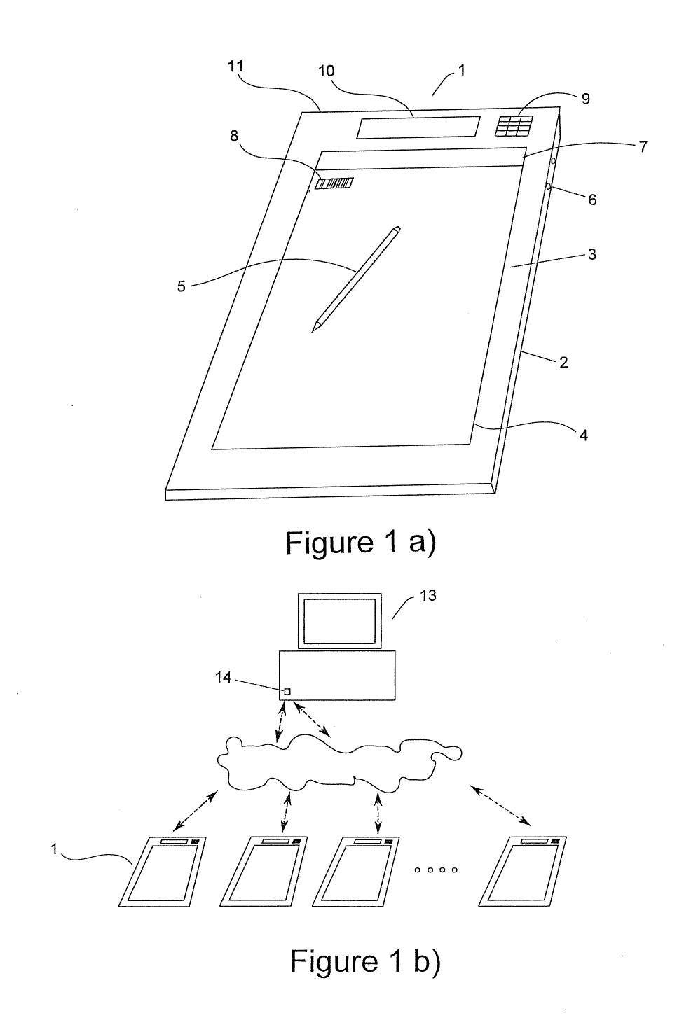

Turning now to FIG. 1 a) the novel portable data entry device illustrative of the invention 1 is shown. Data entry device 1 comprises a housing 2 which contains and protects a pressure sensitive digitizing surface 3 as well as internal electronics and batteries (not shown). A standard piece of paper 4 which can be written upon by any kind of standard writing too such as a pencil, or pen 5 lies on top of the digitizing surface 3. The digitizing surface under the paper is sensitive to the pressure of the tip of the pen as it writes and the impression of the pen tip on the digitizing surface generates electronic data representative of each writing stroke as it is written on the paper. The piece of paper 4 contains a pre-recorded indexing mark 8 which is used to synchronize the writing made on the sheet of paper to the electronic data captured by digitizing surface 3. The index mark 8 is preferably a standard bar code but it may be any kind of identifying mark, and may be a mark that a user writes him or herself on the paper. The writing device contains means (not shown) for reading the indexing mark and data storage means for linking the electronic representation of writing with the indexing mark for each page written upon. In a preferred embodiment a CCD camera is used in combination with an optical sensing system such as a lens located underneath the paper to detect and read page indexing marks through the paper. Alternately, the index mark reading means could include the use of a solid state scanner. A microphone/headset jack 6 and a speaker, not shown, is included in the writing device which allows the capability of recording and playing back audio data either in association with written material or independent of it. A video camera and a suitable display may also be incorporated into the device to allow recording or playing back of video as well as audio information.

At least one integrated clip 7 securely holds the paper to the digitizing surface. Sensors underneath the integrated clip detects when a piece of paper is placed on the digitizing surface and readies the device for operation. A keypad 9 located near the top of the apparatus includes keys or buttons which allow a user to enter data directly into the pad, and also to communicate interactively with an instructor or supervisor who is operating appropriate software on a remote device such as a PC, netbook, PDA, smart phone, another portable data entry device or the like. An LCD screen 10 provides information about the operational state of the device and can be used to give instructions on how to use the device.

An 802.xx data transceiver 11 (not visible) is located on the top of the device and is used to communicate with other devices and transmit data recorded electronically by the device. A connector 12 (not visible) also on the top allows the device to be connected to a docking station for data transfer and to recharge the batteries (not shown) which power the system.

FIG. 1 b) shows a plurality of portable data entry devices operating simultaneously and communicating wirelessly with a base data processing device 13, in this case a desktop computer through a wireless 802.xx data transceiver 14. In one operating mode the data transmitted corresponds to a combination of recognized and ambiguous hand written character data generated by the software within the inventive data entry device. In another operating mode the data transmitted represents keypad 9 choices made by a user in response to interactive queries received from an instructor or supervisor. In yet another operating mode the data transmitted by the devices to a base data processing device represents alpha-numeric data which a user generates by tapping a stylus, pen, finger or the like onto a virtual keypad placed on top of the digitizing surface. The data transmitted by each device can also include audio information recorded via a microphone or headset either alone or in combination with any of the above types of data. The two headed arrows in FIG. 1 b) represent two way communication between the base computer 13 and the plurality of portable data entry devices which allows the workflow between the devices to be in either direction. For example, if may be desirable in certain situations for the base data processing device to send data processing tasks to the plurality of portable data entry devices to take advantage of their data processing capabilities.

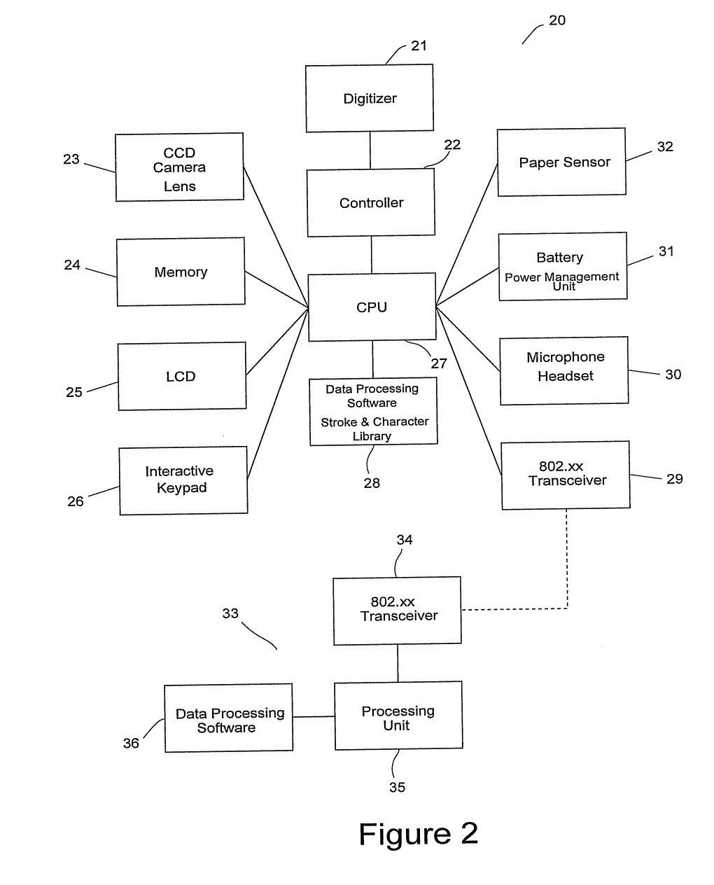

Referring now to FIG. 2, the functional components of portable data entry device 1 are represented by a general schematic 20. A controller 22 manages the flow of data from digitizer surface 21 to a CPU 27 where it is processed by software located in RAM 28. The data processing software in RAM 28 delineates strokes and stroke sets from the incoming data and compares the resultant strokes and stroke sets to the stroke and character library for an initial rapid determination of some easily identified, non-ambiguous characters. In other words, the data processing software of the inventive device acts as a data filter, the output of which is a data stream of some easily recognized characters which can be efficiently represented by an encoded format, such as ASCII, amid less easily defined stroke set data. The output of this process is stored in non-volatile memory 24 which is preferably inexpensive commonly available 1 GB storage memory. When memory 24 reaches a predetermined level of stored data or when required by the application workflow CPU 27 initiates a data transfer via a wireless transceiver 29 to a corresponding transceiver 34 connected to a base data processing unit 35, which can be a PC, netbook, PDA or the like. The data sent to base data processing unit 35 is a mix of vector based raw stroke data, including timing information, and encoded character data corresponding to non-ambiguous stroke sets. The data sent by the portable data entry device is received at base data processing unit 35 via an 802.xx transceiver 34 and is subsequently processed using suitable data processing software 34. The software 34 may include specialized handwriting recognition software, for example ICR (Intelligent Character Recognition) software and may also include software for recognizing and transforming audio information to text. In some situations the flow of data will be from the base data processing unit to the portable data entry device, for example when it is desirable to take advantage of the data processing capabilities of the data entry device to support a task required by the base data processing unit.

CPU 27 is functionally connected with a CCD camera and lens combination 23 which recognizes and records indexing marks present on the paper copies so that all of the stored electronic stroke and character data is indexed to the original papers on which they were drawn. In a preferred embodiment a fisheye lens is used which allows indexing marks to be detected and recognized through the paper.

Also connected to CPU 27 is a battery and power management module 31, which powers the writing device, and a microphone/headset 30 for recording audio information. In a preferred embodiment recorded audio data is processed and compressed using standard audio compression techniques prior to storage in memory 34. An LCD display module 25 is also connected to CPU 27 which is used to display pertinent operational information to a user.

An interactive keypad 26 is also connected to CPU 27 which allows users of the device to communicate interactively in real time with an instructor or supervisor. In one embodiment an instructor can simultaneously ask a number of users questions to which they provide answers by selecting and pressing appropriate buttons on the interactive keypad 26. This allows the instructor to receive immediate feedback during lessons and gives them valuable information about the strength and weaknesses of each student.

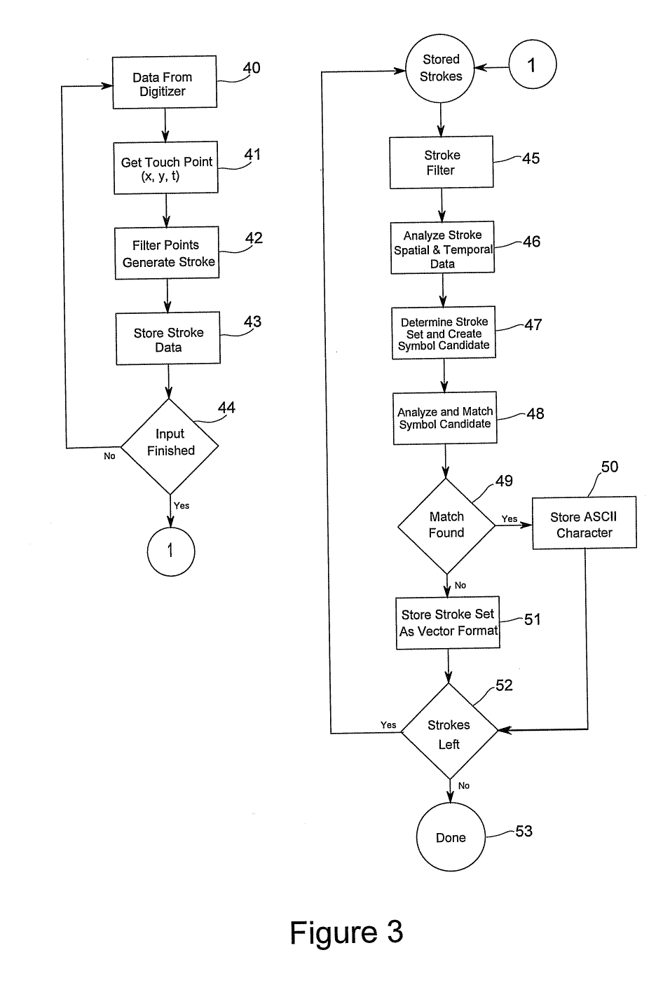

FIG. 3 is a simplified flowchart representing the flow of data within the inventive data entry device when it is in a hand writing recording mode of operation. Digital data is generated at step 40 as a user presses the tip of a pen or pencil or the like onto a piece of paper that is lying on top of a pressure sensitive digitizing surface. The raw data from the digitizer is a stream of x and y points corresponding to points on the digitizer surface and is recorded at a configurable point pairs per second rate. Redundant data is discarded and a timestamp is attached to the remaining unique vector data at step 41 so that each data point is now in the form of (x, y, t) where t is the time that the point x, y was written onto the digitizer surface. At step 42 the stream of data is analyzed and mapped into strokes where the beginning of a stroke is defined by the pencil or pen tip first touching the digitizing surface and the end of the stroke is defined by the tip lifting off the surface. The stroke data is then filtered and data points that are unnecessary to define the stroke are removed so that only the minimum number of points that are needed to define the stroke as written are stored at step 43 in memory. The steps 40-43 are repeated at step 44 until the user is finished writing strokes on the page.

The next data processing steps 45-53 analyze the stoke vector data generated in steps 40-44 in a preliminary attempt to map the vector data into character data which can be encoded and stored in a compressed encoding format. At step 45 the vector data is filtered to remove any noise or unwanted artifacts from the writing process such as a palm or finger resting on the digitizing surface or writing strokes written outside of target areas. Clean vector data is analyzed at step 46 using temporal data to determine candidate character strokes which are then compared in step 47 with other candidate strokes and combined into sets of candidate character strokes for further analysis at step 48 where they are compared with a stored library of sample characters or symbols. If a candidate set of character strokes is judged to be sufficiently similar to a particular library character or symbol it is stored at step 50 in memory using a standardized encoding format, for example ASCII, for that character. If a strong match for a candidate set of characters strokes is not found it is stored in vector format at step 51. The process continues at step 52 until all the strokes stored in memory have been analyzed.

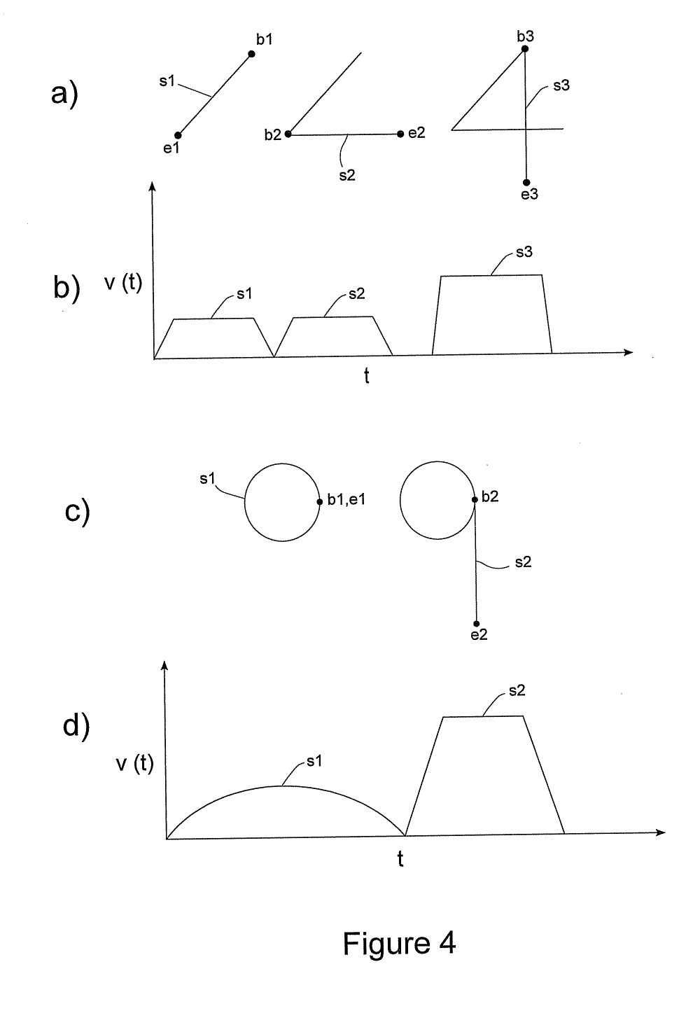

FIG. 4 illustrates by example one possible method of using both spatial and temporal data to characterize and recognize numerical characters recorded using the inventive data entry device. In FIG. 4 a) a sequence of 3 strokes is illustrated sequentially which together represent the number “4”. The first stroke, s1 begins at b1 and ends at e1. The second stroke, s2 begins at b2 (which corresponds to e1) and ends at e2. The third and final stroke begins at b3 (which corresponds to b1) and ends at e3. Each stroke is represented digitally by a set of x, y coordinate pairs representing the points on the digitizer surface that were activated by the pressure of the pen tip as the strokes were drawn on the paper. In addition to spatial data, the inventive writing device also records temporal data about each stroke that is written which can be used to identify individual strokes as well as characters. FIG. 4 b) is a stroke velocity versus time graph for each of the strokes in FIG. 4 a). Each stroke s1-s3 is shown to have a steep increase in velocity initially followed by a longer period of constant velocity and finally a short period of rapid decrease in velocity. The small gap between stroke s2 and s3 corresponds to the time when the tip of the pen is lifted off the paper to reposition it to point b3 (b1) from e2. Turning now to FIG. 4 c) a sequence of 2 strokes is illustrated sequentially which together represent the number “9”. The first stroke, a circular shape, s1, begins at b1 and ends at e1. The second stroke, s2, begins at b2 (which corresponds to b1 and e1) and ends at e2. FIG. 4 d) is a stroke velocity versus time graph for each of the two strokes of FIG. 4 c). The first stroke, s1, has a gradual increase in velocity followed by a long period of constant velocity and a gradual decrease in velocity. Stroke s2 begins immediately after the end of stroke s1 and has a profile similar to the straight lines represented in FIG. 4 a) and b). The numbers “4” and “9” can be ambiguous if they are analyzed solely by static visual recognition methods since they are similarly shaped but one can see by comparing the two graphs of stroke velocity the two numbers have different velocity profiles which can be used to differentiate the two sets of strokes.

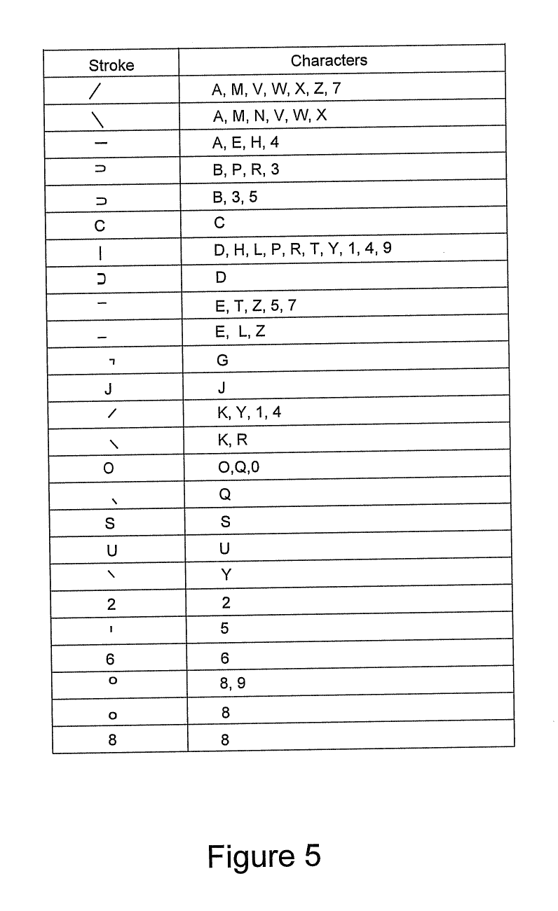

FIG. 5 is one example of a table of elemental strokes and their associated characters which is representative of a stroke-character library used by the inventive portable data entry device to analyze sets of strokes. The data processing software within the device could include a plurality of such tables representing a number of different languages, writing styles and sets of non-alphabetic symbols. One can see from the table that some characters such as “C”, “D” or “U” are uniquely defined by a stroke which no other character features and are therefore good candidates for non-ambiguous character identification given an accurate identification of the unique stroke by the writing device software. The “S” stroke, while unique to the letter “S” can also be used to represent the number “5”, although improperly, and this possibility would make the “S” stroke an ambiguous one which would require the character recognition resources of a dedicated base processing unit for a reliable discrimination. The data processing software may contain feedback means which uses the results from previous writing recognition sessions to improve both the accuracy and the speed of recognizing and encoding non-ambiguous written characters.

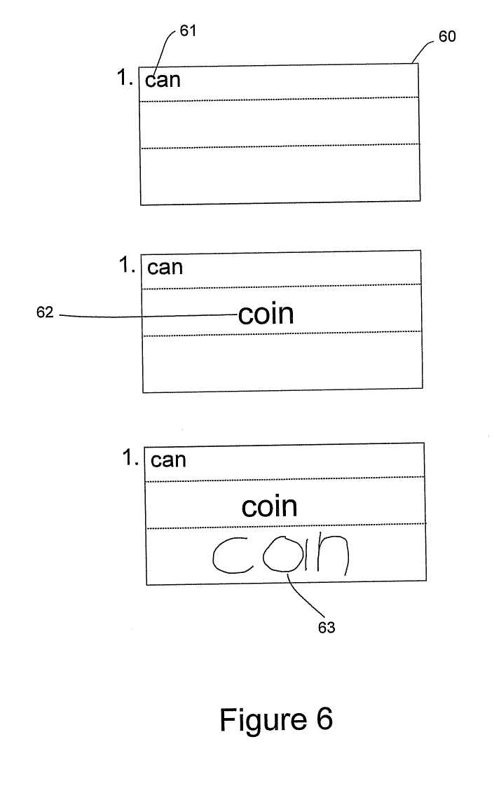

FIG. 6 illustrates a display window 60 of a software program running on a base data processing device that receives data written on a portable data entry device. A test word 61 is displayed in the top portion of the display window and represents what the user of a portable data entry device is required to reproduce on the portable data entry device. An encoded non-ambiguous word 62 is received from the portable data entry device which is similar to, but not identical to the test word 61. Vector data is also sent along with the encoded non-ambiguous data and can be used to generate a word 63 which is substantially identical to what was originally written on the data entry device. Timing data associated with the start and end time of each writing stroke is also sent to the base data processing device along with the vector data and can be used to display vector based words in a stroke sequential manner which is advantageous to gain insight into the performance of the student using the data entry device. The operator of the base device can choose to vary the playback speed of a word displayed in a stroke sequential mode.

The present invention has been described with reference to preferred embodiments but it will be readily appreciated to those of ordinary skill in the art that many modifications and alternate configurations are possible without departure from the spirit and scope of the invention as claimed hereafter.

What is claimed is:

1. A portable data entry apparatus for recording hand written data comprising:
a pressure sensitive digitizing surface;
data processing means for: receiving spatial data points from writing strokes written upon said digitizing surface; generating timestamp data for each received spatial data point; and storing said spatial and timestamp data as vector and timestamp data;
data storage means for storing said vector and timestamp data;
data transmission means for transmitting said vector and timestamp data stored in said data storage means to a base processing apparatus for further processing;
a power supply for supplying power to said digitizing surface, said data processing means, said data storage means and said data transmission means; and
a housing integrally incorporating said digitizing surface, said data processing means, said data storage means, said data transmission means and said power supply.

2. An apparatus according to claim 1 wherein said writing strokes are written upon a writing surface temporarily placed on top of said digitizing surface and wherein the writing strokes are simultaneously written on the writing surface and impressed on the digitizing surface.

3. An apparatus according to claim 2 wherein said writing surface is paper.

4. An apparatus according to claim 2 further comprising index mark detecting means integral with said housing, said means able to detect an index mark on said writing surface wherein said index mark is used to map vector and timestamp data stored in said data storage means to writing on a particular writing surface.

5. An apparatus according to claim 4 wherein said index mark detecting means includes a photo-optic sensor capable of sensing light passing through the writing surface.

6. An apparatus according to claim 5 wherein said photo-optic sensor includes a CCD sensor integral with a lens or a solid state scanner.

7. An apparatus according to claim 1 wherein said data processing means further comprises:
stroke analysis means for analyzing said vector and timestamp data to map the data to a set of plausible writing strokes and stroke sets;
character mapping means for mapping said plausible writing strokes and stroke sets to non-ambiguous written characters; and
data encoding means for encoding said non-ambiguous written characters into a compressed data format.

8. An apparatus according to claim 7 wherein said data storage means includes a stroke and character library used by said stroke analysis means and said character mapping means.

9. An apparatus according to claim 7 wherein said vector and timestamp data and said encoded non-ambiguous character data is transmitted to said base processing apparatus for further processing and storage.

10. An apparatus according to claim 1 wherein said housing further includes a data port for connecting the apparatus by cable to a base processing unit for transmission of data.

11. An apparatus according to claim 10 wherein said data port is used to connect the apparatus by cable to a power source to recharge said power supply.

12. An apparatus according to claim 4 further comprising:
a data entry template integral with a particular writing surface having an index mark;
data entry template processing means integral with said data processing means; and
a data entry template translation table stored in said data storage wherein said index mark is used by said processing means to map a particular data entry template to a matching data translation table for recording non-written data entered on said writing surface.

13. An apparatus according to claim 12 wherein said data entry template represents an alpha-numeric keypad.

14. An apparatus according to claim 1 further comprising:
programming control means integral with said data processing means wherein said base processing apparatus can remotely control and use the data processing means of the portable data entry apparatus.

15. An apparatus according to claim 1 wherein the vector and timestamp data transmitted to the base processing apparatus is used to display a stroke sequential facsimile of the original written data.

16. An apparatus according to claim 15 further comprising display control means to vary the playback speed of said stroke sequential facsimile.

17. An apparatus according to claim 7 further comprising power monitoring means integral with said data processing means which monitors the amount of power remaining in the power supply means and overrides stroke analysis, character mapping and data encoding if the remaining power is below a predetermined threshold.

18. An apparatus according to claim 1 wherein said base processing apparatus receives data transmissions from a plurality of portable data entry apparatus.

19. An apparatus according to claim 14 wherein said base processing apparatus remotely controls and uses the data processing means of a plurality of portable date entry apparatus.

20. An apparatus according to claim 2 further comprising writing surface sensing means integral with said housing which detects the presence of a writing surface and initiates the apparatus for use.

21. An apparatus according to claim 20 wherein said writing surface sensing means includes at least one spring loaded clip which securely holds the writing surface onto said digitizing surface.

22. An apparatus according to claim 1 wherein said data transmission means includes wireless transmission using the 802.xx protocol.
